(19) United States
(12) Patent Application Publication
(10) Pub. No.: US 2016/0048120 A1
(43) Pub. Date: Feb. 18, 2016

(54) PROGRAMMABLE LOGIC CONTROLLER SYSTEM AND PROGRAMMABLE LOGIC CONTROLLER

(71) Applicant: MITSUBISHI ELECTRIC CORPORATION, Tokyo (JP)

(72) Inventor: Keisuke NAKAJIMA, Tokyo (JP)

(73) Assignee: Mitsubishi Electric Corporation, Tokyo (JP)

(21) Appl. No.: 14/779,369

(22) PCT Filed: Apr. 22, 2013
(86) PCT No.: PCT/JP2013/002680

§ 371 Date: Sep. 23, 2015

(51) Int. Cl. G05B 19/05

(52) U.S. Cl. CPC G05B 19/058; G05B 2219/24007

(57) ABSTRACT

In the PLC system, the setting information can be backed up by detecting the change of the setting information on a device in the PLC system, and, the system configuration information, the date and time at which the setting information was backed up, and the target device are written in the system file when the setting information is backed up and a restore can only be performed on a device on which a restore should be performed in accordance with the information stored in the system file. Therefore, it is possible to definitely perform a backup and efficiently perform backup and restore in terms of performance and memory capacity used.

### FIELD

The present invention relates to, in a programmable logic controller system and a programmable logic controller, a function of efficiently backing up and restoring setting values of a device on the same network as the programmable logic controller (hereinafter, referred to as “PLC”).

### BACKGROUND

Conventionally, at manufacturing sites, it is necessary to back up or restore parameter setting values of devices that have a communication function and are connected to a programmable logic controller via a network (hereinafter, referred to as “device”) in preparation for a changeover or a failure. A representative example of such a device is a sensor.

There is a disclosure in Patent Literature 1 of a technology for backing up or restoring the setting values of a designated device without using a program.

### CITATION LIST

### Patent Literature

Patent Literature: 1: Japanese Patent Application Laid-open No. 2011-215814

Patent Literature 2: Japanese Patent Application Laid-open No. 2002-297207

Patent Literature 3: Japanese Patent Application Laid-open No. H11-143506

Patent Literature 4: Japanese Patent Application Laid-open No. 2009-187373

### SUMMARY

### Technical Problem

However, when the setting values of the devices are backed up by manually sending, to a PLC or the like, a command to store the setting values of the devices in a predetermined storage medium, there is a problem in that the user may forget to back up the setting values of the devices when they are changed.

There is also a problem in that it takes time to perform a backup selectively on the device that has had its setting values changed.

In order to avoid the above problems, a method has been considered in which the setting values of all the devices in the PLC system are backed up; however, there is a problem in that this method is wasteful in terms of backup performance and memory capacity used in the PLC system.

Moreover, when the setting values of all the devices in the PLC system need to be restored to those at a given point in time, it is necessary with the conventional technologies to back up in advance the setting values of all the devices in the system at a given point in time and then restore the setting values thereto; therefore, there is a problem in that it is wasteful in terms of restore performance and memory capacity used.

The present invention has been achieved in view of the above and an object of the present invention is to enable the setting values of all the devices in the PLC system to be definitely and efficiently backed up and to enable the setting values of all the devices in the PLC system to be efficiently restored to those at a given point in time by performing a restore.

### Solution to Problem

In order to solve the above problems and achieve the object, an aspect of the present invention is a programmable logic controller system including: devices that store device setting information for controlling the devices and, when the device setting information has been changed, notify another programmable logic controller that a change has occurred; and a programmable logic controller that stores the device setting information on the devices in a storage unit and, when a notification indicating that the device setting change has occurred is received, updates, among the device setting information stored in the storage unit of itself, device setting information corresponding to a device from which the notification is received to latest device setting information stored in the device.

Moreover, according to another aspect of the present invention, the programmable logic controller is capable of causing the device setting information stored in the storage unit to be stored again in a device corresponding to the device setting information.

### Advantageous Effects of Invention

According to the present invention, when the change of the device setting information on a device in the PLC system is detected, the device setting information is backed up; therefore, the device setting information can be definitely backed up and thus it is possible to prevent a backup of the device setting information from being forgotten.

### BRIEF DESCRIPTION OF DRAWINGS

FIG. 1 is a block diagram illustrating a PLC system according to a present embodiment.

FIG. 2 is a schematic diagram illustrating content of a system file.

FIG. 3 is a schematic diagram for describing a method of backing up device setting information on devices connected to a PLC.

FIG. 4 is a flowchart describing operations of the backup method.

FIG. 5 is a schematic diagram for describing a method of restoring setting information on the devices connected to the PLC.

FIG. 6 is a flowchart describing operations of the restore method.

FIG. 7 is a block diagram illustrating a PLC system according to a second embodiment.

### DESCRIPTION OF EMBODIMENTS

### First Embodiment

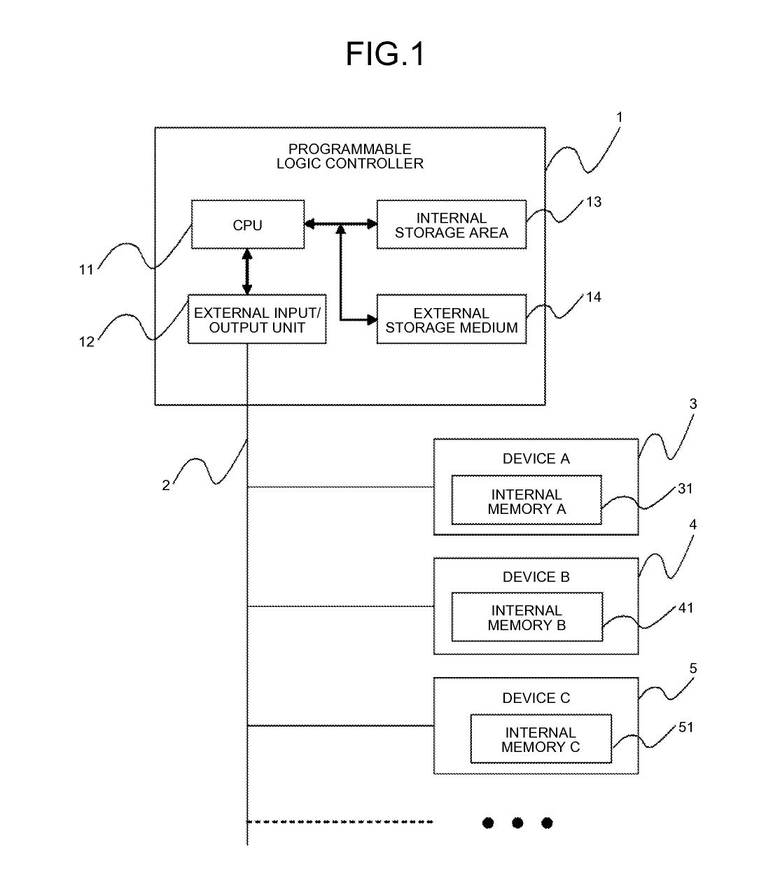

FIG. 1 is a block diagram illustrating an example of the configuration of a PLC system according to the present embodiment. The PLC system is configured such that a plurality of devices 3 (4, 5) are connected to a PLC 1 via a network 2. The devices 3 (4, 5) are, for example, sensors having a function to communicate with the PLC connected thereto via the network 2 and store, in internal memories 31 (41, 51), the setting values (hereinafter, referred to as “device setting information”), such as a threshold, that are necessary for the devices' on operations. When the device setting information stored in the internal memories 31 (41, 51) is changed, the devices 3 (4, 5) notify the PLC 1, to which the devices 3 (4, 5) are connected, that the device setting information has been changed. The device setting information is not limited to a threshold and it is satisfactory if the device setting information is information that contributes to device operations, such as a value that sets the operation range of a sensor or an alarm value.

The PLC 1 is configured such that a CPU 11, an external input/output unit 12, an internal storage area 13, and an external storage medium 14 are connected to each other via, an internal bus. The CPU 11 functions as an arithmetic processing unit that executes various arithmetic. processes. When it is detected that an additional device 3 (4, 5) has been connected to the PLC 1 via the network, the CPU 11 reads the device setting information from the internal memory 31 (41, 51) of the detected device 3 (4, 5) via the external input/output unit 12. The CPU 11 temporarily stores the read device setting information in the internal storage area 13.

When the CPU 11 reads the device setting information from the internal memory 31 (41, 51) of the device 3 (4, 5), the CPU 11 checks the address information. on the internal memory 31 (41, 51) in which the device setting information is stored, creates restore procedure information, and associates the address information and the restore procedure information with corresponding device setting information.

Next, the CPU 11 stores the device setting information and the address in and the restore procedure information corresponding to the device setting information in the external storage medium 14, for example, at a timing when a backup command is received as an external command, a timing when the setting information is read in the internal storage area 13, or at a timing when a predetermined period has elapsed after the device setting information was read. At this point, the CPU 11 checks the address information in the external storage medium 14 that stores the device setting information and creates backup procedure information, and then associates the address information and the backup procedure information with the corresponding device setting information and stores them in the external storage medium 14 together with the device setting information. The external storage medium 14 is used as a storage medium for a backup; however, the device setting information may be stored in an internal storage medium, such as a non-volatile memory, or an external server to which the PLC is connected as long as the storage can back up the device setting information.

The backup procedure information and the restore procedure information are information on the backup procedure and information on the restore procedure, respectively. The backup procedure and the restore procedure are arranged for each device. The above information is, for example, configured by arranging commands used for backup and restore and information on arguments in order of use.

In the present embodiment, when the CPU 11 of the PLC 1 receives a notification indicating that the device setting information stored in the internal memory 31 (41, 51) of the device 3 (4, 5) has been changed, the CPU 11 reads the device setting information stored in the internal memory 31 (41, 51) of the device on which a backup is to be performed and overwrites the device setting information stored in the external storage medium 14 of the PLC 1, i.e., performs a backup, in accordance with the address information in the external storage medium 14 in which the read device setting information is stored and the backup procedure information for reading the device setting information.

When the CPU 11 of the PLC 1 receives a restore command as a command from an external source, the CPU 11 reads the device setting information stored in the external storage medium 14 to the internal storage area 13, and causes the internal memory 31 (41, 51) of the device 3 (4, 5) on which a restore is to be performed to store the read device setting information, i.e., performs a restore, in accordance with the address information stored in the device setting information stored in the internal memory 31 (41, 51) of the device 3 (4, 5) and the restore procedure information for writing the device setting information.

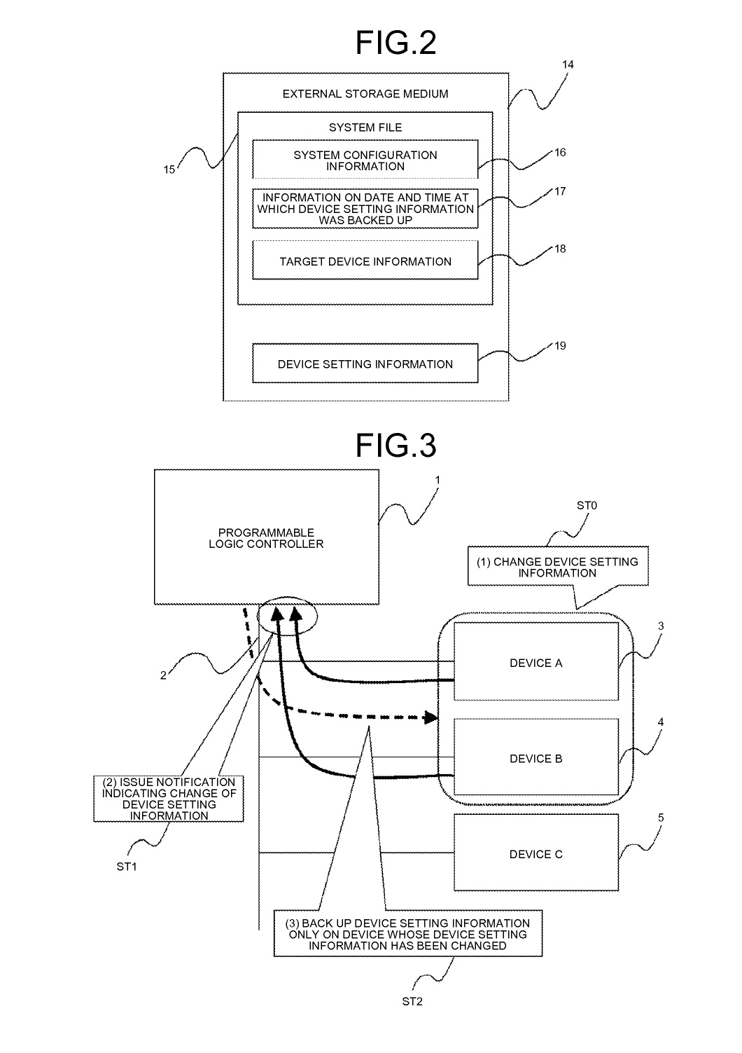

An explanation will be given here of the file composition of the external storage medium that stores therein the device setting information with reference to FIG. 2. As illustrated in FIG. 2, the external storage medium 14 stores therein a system file 15 and device setting information 19. The system file 15 includes at least system configuration information 16, date and time 17 at which the device setting information was backed up, and a target device 18.

The system configuration information 16 is information that indicates what and how many devices are connected and where the devices are connected in the PLC system, i.e., the type and the number of the devices 3 (4, 5) connected to the PLC 1 and the addresses of the devices, at a point in time when the device setting information is backed up. The system configuration information 16 is an information group that is used for checking the system configuration when the system configuration is restored to that at a given point in time.

The information on date and time 17 at which the device setting information was backed up is the date and time at which the device setting information was backed up in the external storage medium 14 and is an information group that is used for, when the system configuration is restored to that at a given point in time, determining the backup date and time of the device setting information to which the device setting information should be restored.

The target device information 18 is information that indicates which device in the PLC system was backed up by the CPU 1. The target device information 18 is an information group that is used for, when the system configuration is restored to that at a given point in time, determining to which device's backed-up device setting information the device setting information should be restored.

The device setting information 19 is an information group including date and time at which the device setting information was backed up and the device setting information stored for each target device.

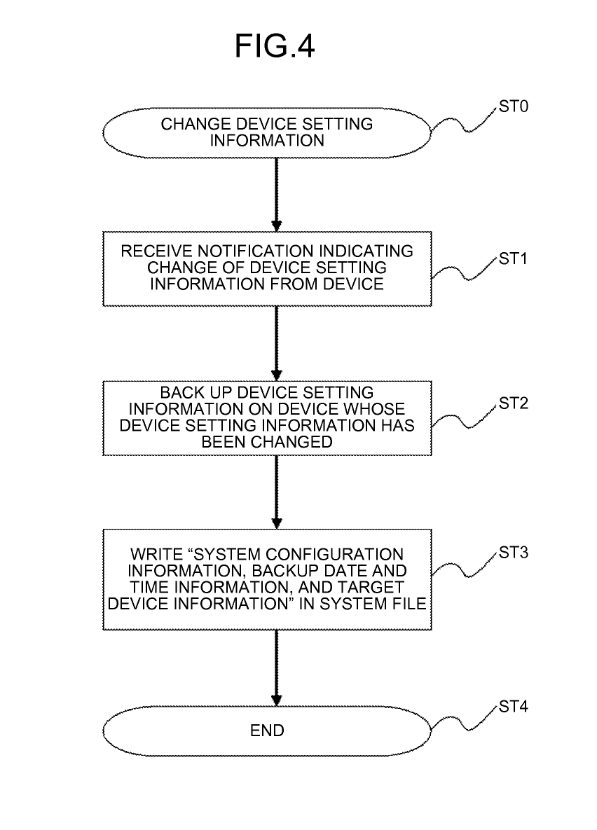

Next, an explanation will be given of a method of backing up the device setting information according to the present embodiment with reference to FIG. 3 and FIG. 4. FIG. 3 is a diagram illustrating a method of backing up the device setting information on the devices 3 (4, 5) connected to the PLC 1. FIG. 4 is an operational flowchart of the backup method performed by the PLC 1.

With the PLC system, for example, when the device setting information on a device A3 and a device B4 is changed by a user operation or the like (ST0), the device A3 and the device B4 notify the PLC 1 that the device setting information has been changed. When the CPU 11 of the PLC 1 receives a notification indicating that the device setting information has been changed (ST1), the CPU 11 reads the changed, i.e., latest, device setting information from each of the devices from which the CPU 11 has received the notification of the change and backs up (stores) the read device setting information in the storage area of the device setting information 19 stored in the external storage medium 14 (ST2).

Next, after the CPU 11 backs up the device setting information in the storage area of the device setting information 19, the CPU 11 writes, in a predetermined storage area of the system file 15, the system configuration information 16 corresponding to the device installation, the information on date and time 17 at which the device setting information was backed up, and the target device information 18 (ST3). Then, after the CPU 11 backs up the changed device setting information on the device A3 and the device B4 from which the CPU 11 has received the notification of the change, the CPU 11 ends the backup process (ST4).

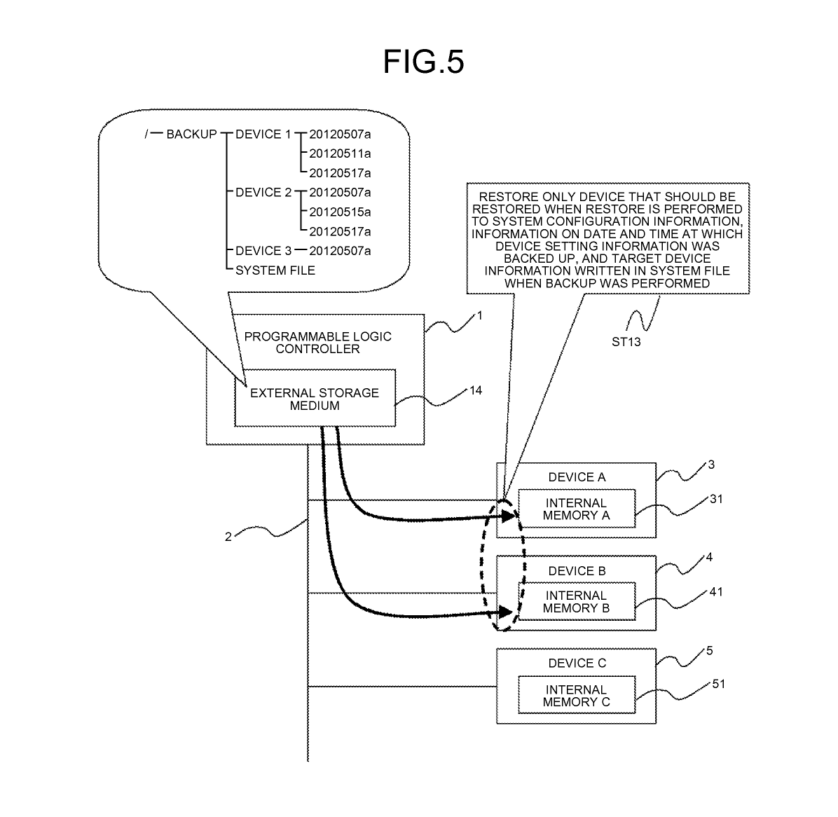

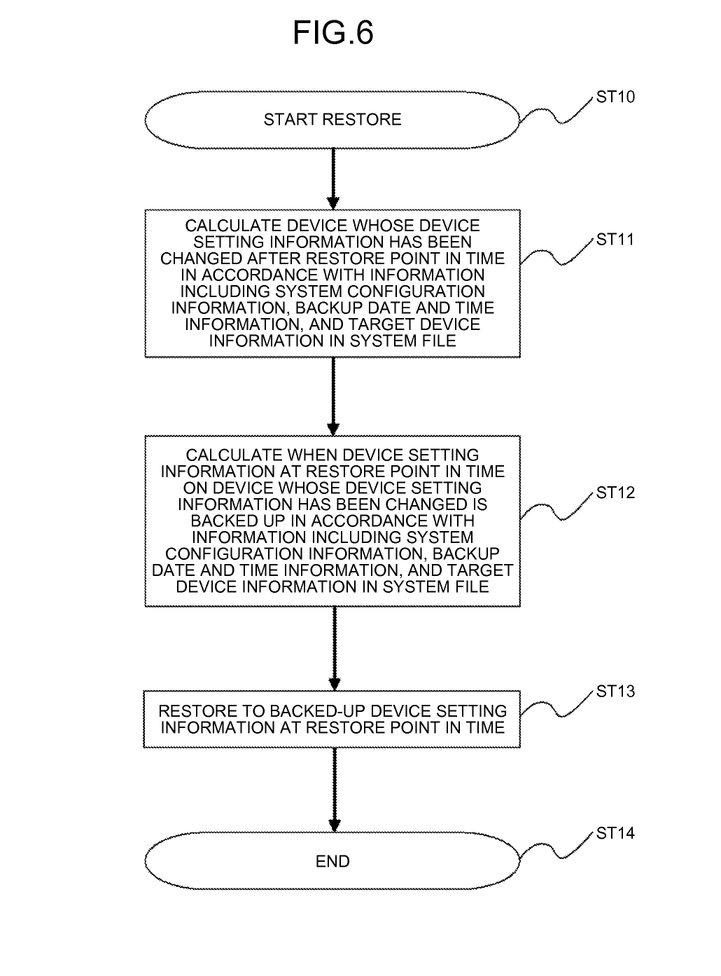

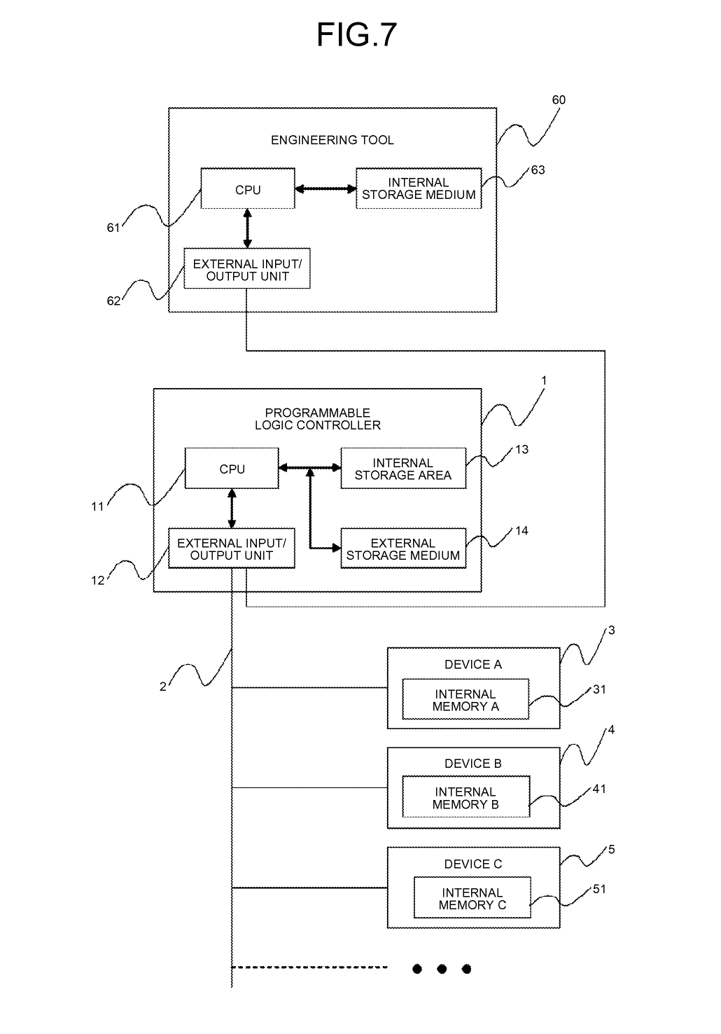

Next, an explanation will he given of a method of restoring the device setting information according to the present embodiment with reference to FIG. 5 and FIG. 6. FIG. 5 is a diagram illustrating a method of restoring the device setting information on the device A3 and the device 54 connected to the PLC 1. When a point in time is designated to which the system is to be restored, the PLC 1 restores the setting information on the device A3 and the device B4 in accordance with the information in the system file stored in the external storage medium 14. FIG. 6 is an operational flowchart of the restore method performed by the PLC 1.

When the CPU 11 of the PLC 1 receives a restore command, the CPU 11 starts a restore (Step ST10). First, the CPU 11 calculates a device whose device setting information 19 has been changed after the restore point in time in accordance with the information including the system configuration information 16, the information on date and time 17 at which the device setting information was backed up, and the target device information 18, which is a device name and is stored in the external storage medium 14, in the system file 15 (Step ST11). The point after the restore point in time indicates a point after the point in time when the CPU 11 can restore the device setting information to that after a desired point in time when a backup was performed and the point in time when this restore process is started.

Next, the CPU 11 calculates when the device setting information at the restore point in time on the device whose device setting information 19 has been changed is backed up in accordance with the information including the system configuration information 16, the information on date and time 17 at which the device setting information was backed up, and the target device information 18 in the system file 15 (Step ST12).

Next, the CPU 11 restores the corresponding device A3 and device B4 to the backed-up device setting information 19 at the restore point in time (Step ST13).

As described above, when the change of the device setting information on a device in the PLC system is detected, the device setting information is backed up; therefore, the device setting information can be definitely backed up and thus it is possible to prevent a backup from being forgotten. Moreover, when the change of the device setting information on a device in the PLC system is detected, the device setting information is backed up; therefore, a backup can only be performed on the device on which a backup should be performed. Therefore, it is possible to reduce the time required for a backup and the memory capacity.

Moreover, the system configuration information, the date and time at which the device setting information was backed up, and the target device are written in the system file when the device setting information is backed up and a restore can only be performed on a device on which a restore should be performed in accordance with the information stored in the system file. Therefore, it is possible to reduce the time required for a restore and the memory capacity.

According to the present invention, when the change of the device setting information on a device in the PLC system is detected, the device setting information is backed up; therefore, a backup can only he performed on the device on which a backup should be performed. Therefore, an effect is obtained where it is possible to reduce the time required for a backup and the memory capacity.

Moreover, according to the present invention, the system configuration information, the date and time at which the device setting information was backed up, and the target device are written in the system file when the device setting information is backed up and a restore can only be performed on a device on which a restore should be performed in accordance with the information stored in the system file. Therefore, an effect is obtained where it is possible to reduce the time required for a restore and the memory capacity.

### Second Embodiment

A PLC system according to the present embodiment is configured such that an engineering tool 60 is connected to the PLC 1 in the PLC system described in the first embodiment. The engineering tool 60 has a function of collectively managing the PLC 1 and the devices connected to the PLC 1. The engineering tool 60 is configured such that the device setting information on a sensor can be changed on the engineering screen.

The engineering tool 60 is configured such that a CPU 61, an external input/output unit 62, and an internal storage medium 63 are connected to each other via an internal bus. The CPU 11 functions as an arithmetic processing unit that executes various arithmetic processes. The CPU 61 functions as a processing unit that manages the device setting information corresponding to each device by executing a predetermined application stored in the internal storage medium 63 and functions as a processing unit that changes the setting of the device setting information on the device 3 (4, 5) via the network 2. The device setting information is stored in the internal storage medium 63.

When the engineering tool 60 changes the device setting information on the device 3 (4, 5) via the PLC 1 and the network 2, the device 3 (4, 5) notifies the PLC 1 that the device setting information thereon has been changed. In the present embodiment also, the PLC 1 can back up the device setting information in the external storage medium 14 in a similar manner to the first embodiment. When the PLC 1 receives a restore command, the PLC 1 restores the device 3 (4, 5) to the device setting information stored in the external storage medium 14.

In the present embodiment, the engineering tool 60 changes the device setting information on the devices 3 (4, 5) indirectly via the PLC 1; however, the engineering tool 60 may be directly connected to the devices 3 (4, 5) and thus change the device setting information in the devices 3 (4, 5).

According to the present invention, even when the device setting information on the devices 3 (4, 5) is changed by the engineering tool 60, it is possible to prevent a backup of the device setting information from being forgotten.

### INDUSTRIAL APPLICABILITY

As described above, the present invention is suitable for saving and restoring of the setting information on the device in the PLC system.

### REFERENCE SIGNS LIST

1 PLC

2 network

3, 4, 5 device

31, 41, 51 internal memory

11, 61 CPU

12, 62 external input/output unit

13 internal storage area

14 external storage medium

15 system file

16 system configuration information

17 date and time

18 target device

19 device setting information

60 engineering tool

63 internal storage medium

1. A programmable logic controller system comprising:
devices that store setting information for controlling the devices and, when the setting information has been changed, notify another programmable logic controller that a change has occurred; and
a programmable logic controller that stores the setting information on the devices in a storage unit and, when a notification indicating that the setting change has occurred is received, updates, among the setting information stored in the storage unit, setting information corresponding to a device from which the notification is received to latest setting information stored in the device.

2. The programmable logic controller system according to claim 1, wherein the storage unit is an external storage medium of the programmable logic controller.

3. The programmable logic controller system according to claim 1, wherein the programmable logic controller causes the setting information stored in the storage unit to be stored again in a device corresponding to the setting information.

4. The programmable logic controller system according to claim 3, wherein the device is caused to store again the setting information on a basis of a target device and backup date and time.

5. The programmable logic controller system according to claim 1, wherein the setting information stored in the device is changed by an engineering tool connected to the device.

6. A programmable logic controller comprising:
a storage unit that stores setting information on devices that, when setting information for controlling the devices has been changed, notify an external source that the change has occurred; and
an updating unit that, when a notification indicating that the setting change has occurred is received, updates, among the setting information stored in the storage unit, setting information corresponding to a device from which the notification is received to latest setting information stored in the device.

7. The programmable logic controller according to claim 6, wherein the storage unit is an external storage medium of the programmable logic controller.

8. The programmable logic controller according to claim 6, further comprising a unit that causes the setting information stored in the storage unit to be stored again in a device corresponding to the setting information.

9. The programmable logic controller according to claim 8, wherein the device is caused to store again the setting information on a basis of a target device and backup date and time.

10. The programmable logic controller according to claim 6, wherein the setting information stored in the device is changed by an engineering tool connected to the device.
